(19) United States
(12) Patent Application Publication
(10) Pub. No.: US 2024/0303227 A1
(43) Pub. Date: Sep. 12, 2024

(54) CUSTOM RESOURCE SCHEMA MODIFICATION

(71) Applicant: VMware, Inc., Palo Alto, CA (US)

(72) Inventors: Elina Valinkova, Sofia (BG); Martin Petkov, Sofia (BG); Yanitsa Dimitrova Spasova, Sofia (BG); Diana Kovacheva, Sofia (BG); Vera Hadzhilazova, Sofia (BG); Martin Vuchkov, Sofia (BG)

(73) Assignee: VMware, Inc., Palo Alto, CA (US)

(21) Appl. No.: 18/382,117

(22) Filed: Oct. 20, 2023

Related U.S. Application Data
(60) Provisional application No. 63/451,287, filed on Mar. 10, 2023.

(51) Int. Cl. G06F 16/21

(52) U.S. Cl. CPC G06F 16/213

(57) ABSTRACT

Custom resource schema modification is described herein. One example method includes providing an interface for modifying a schema of a custom resource in a virtualized environment. The interface can include a first portion configured to receive modifications to summary information corresponding to the custom resource and a second portion configured to receive modifications to properties corresponding to the schema of the custom resource. The method can include validating the modified schema, and saving the modified schema of the custom resource responsive to the validation being successful.

### BACKGROUND

A data center is a facility that houses servers, data storage devices, and/or other associated components such as backup power supplies, redundant data communications connections, environmental controls such as air conditioning and/or fire suppression, and/or various security systems. A data center may be maintained by an information technology (IT) service provider. An enterprise may utilize data storage and/or data processing services from the provider in order to run applications that handle the enterprises' core business and operational data. The applications may be proprietary and used exclusively by the enterprise or made available through a network for anyone to access and use.

Virtual computing instances (VCIs), such as virtual machines and containers, have been introduced to lower data center capital investment in facilities and operational expenses and reduce energy consumption. A VCI is a software implementation of a computer that executes application software analogously to a physical computer. VCIs have the advantage of not being bound to physical resources, which allows VCIs to be moved around and scaled to meet changing demands of an enterprise without affecting the use of the enterprise's applications. In a software-defined data center, storage resources may be allocated to VCIs in various ways, such as through network attached storage (NAS), a storage area network (SAN) such as fiber channel and/or Internet small computer system interface (iSCSI), a virtual SAN, and/or raw device mappings, among others.

### BRIEF DESCRIPTION OF THE DRAWINGS

FIG. 1 is a diagram of a host and a system for custom resource schema modification according to one or more embodiments of the present disclosure.

FIG. 2 is a flow chart illustrating communication performed to retrieve a custom resource type customized form according to one or more embodiments of the present disclosure.

FIG. 3 illustrates a workflow schema according to one or more embodiments of the present disclosure.

FIG. 4 is a screen shot of an example interface including a deployment according to one or more embodiments of the present disclosure.

FIG. 5 is a screen shot of an example interface associated with customizing the display of custom resources according to one or more embodiments of the present disclosure.

FIG. 6 is a screen shot of an example interface associated with editing a schema as a table according to one or more embodiments of the present disclosure.

FIG. 7 illustrates a system for custom resource schema modification according to one or more embodiments of the present disclosure.

FIG. 8 is a diagram of a machine for custom resource schema modification according to one or more embodiments of the present disclosure.

### DETAILED DESCRIPTION

The term “virtual computing instance” (VCI) refers generally to an isolated user space instance, which can be executed within a virtualized environment. Other technologies aside from hardware virtualization can provide isolated user space instances, also referred to as data compute nodes. Data compute nodes may include non-virtualized physical hosts, VCIs, containers that run on top of a host operating system without a hypervisor or separate operating system, and/or hypervisor kernel network interface modules, among others. Hypervisor kernel network interface modules are non-VCI data compute nodes that include a network stack with a hypervisor kernel network interface and receive/transmit threads.

VCIs, in some embodiments, operate with their own guest operating systems on a host using resources of the host virtualized by virtualization software (e.g., a hypervisor, virtual machine monitor, etc.). The tenant (i.e., the owner of the VCI) can choose which applications to operate on top of the guest operating system. Some containers, on the other hand, are constructs that run on top of a host operating system without the need for a hypervisor or separate guest operating system. The host operating system can use name spaces to isolate the containers from each other and therefore can provide operating-system level segregation of the different groups of applications that operate within different containers. This segregation is akin to the VCI segregation that may be offered in hypervisor-virtualized environments that virtualize system hardware, and thus can be viewed as a form of virtualization that isolates different groups of applications that operate in different containers. Such containers may be more lightweight than VCIs.

While the specification refers generally to VCIs, the examples given could be any type of data compute node, including physical hosts, VCIs, non-VCI containers, and hypervisor kernel network interface modules. Embodiments of the present disclosure can include combinations of different types of data compute nodes.

The present disclosure provides additional value to a workload provisioning platform (sometimes referred to herein as a “cloud automation platform” or simply “platform”), by allowing users to customize how their custom resource types look when provisioned in a deployment. It is noted that throughout the present disclosure, reference is made to the implementation of such a solution in the context of VMware's vRA (vRealize Automation), an infrastructure automation platform. However, the same principles can be applied to a generic platform (e.g., Kubernetes). Users that can create these custom resource definitions are referred to herein as authors. Users that consume the provisioned custom resource are referred to herein as consumers.

For a platform like vRA, it means that out-of-the-box it provides the tools to automate the provisioning of cloud and datacenter-based resources (e.g., virtual machines, containers, networks, data stores) all combined in a package, also known as blueprint, and configured as best as the blueprint author wanted. Very often additional resources are also needed in one such blueprint/workload. These things can be provisioning of a user (e.g., creating an account for the user), calling an internal service to request hardware for the user (e.g., a laptop computing device), and/or updating a record in a database, for instance.

Customers often use custom resources to manage third party integrations. Typically, custom resource types contain a schema with properties, which is automatically generated by the inputs and outputs of the “create” workflow. In vRealize Automation (vRA) 7.x clients were able to change the names of those properties by applying a XaaS form, so they could apply a specific format. Some of the changes included renaming as well as publishing and unpublishing different properties to the deployment card level. In vRA 8.x Custom Resources are static, and their property names cannot be edited or excluded from the deployment view. In addition to that, the Custom Resource deployment view includes only a code view of those properties.

In previous approaches, customers cannot customize how their custom resource types look when provisioned. Properties (e.g., all properties) look like they are in vRealize Orchestrator (vRO) or Action Based Extensibility (ABX). Customers want to be able to customize how their deployed Custom Resources look. For instance, customers may desire to customize the labels of the properties of the resource, as well as custom ordering (or even custom CSS (Cascading Style Sheets)). Prior to having this feature if a user wanted to change the schema, they had to go to the vRO or ABX, change the property and recreate the custom resource.

Schema modification is a powerful feature that provides freedom to customers for performing schema customizations. One of the issues with this freedom is that it can cause user errors especially if the users do not understand how the changes affect properties. We allow the clients to modify the schema as they add new constraints, modify old ones, or change the property and this can break the logic for it. The solution is to add some validations to verify that the modified properties are not broken. If they are broken this will cause errors when the client tries to deploy a blueprint with a custom resource type inside.

Embodiments of the present disclosure address these challenges by allowing clients to modify the custom resource's schema at any time, adding constraints, renaming properties, changing a property's type (e.g., in ABX-based instances), and by allowing adding or removing, hiding, or showing properties. Embodiments of the present disclosure allow different ways of editing a schema. In some embodiments, a schema is edited as a code. A user can change, store and/or reuse already created schemas in YAML format (discussed further below). In some embodiments, a schema is edited as a table, which may be especially useful if the customer is a new user and is not familiar with the properties/schema. Further, embodiments herein add validations for changes (e.g., every change) (discussed further below), improve customer experience, reduce customer errors, and save customer time.

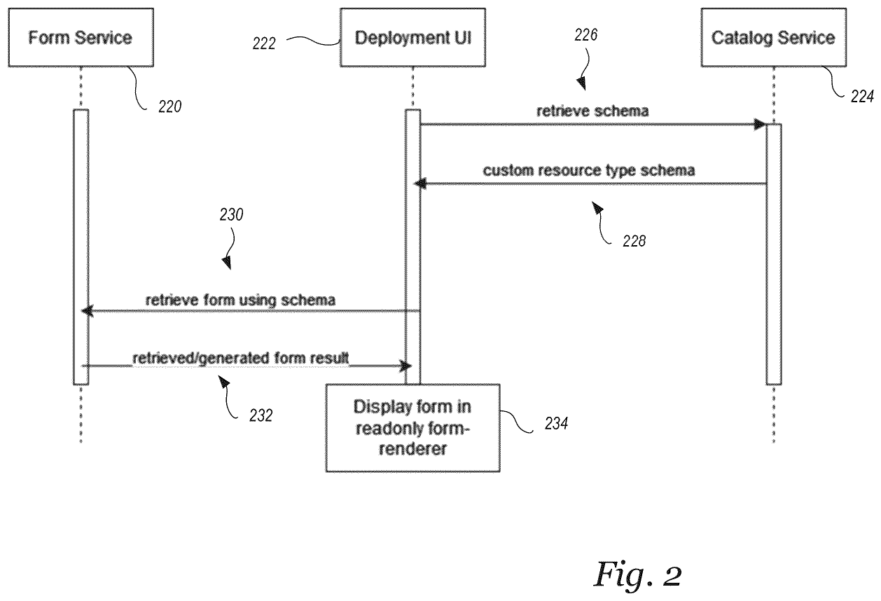

Embodiments of the present disclosure can be considered to include two flows, a user flow and an admin flow. In the user flow, the user can open a deployment that contains a custom resource type. On the canvas, they can select on a custom resource. The deployment user interface (UI) can retrieve the schema of the selected custom resource from the catalog service (table prov_resource_type in catalog-db). The resulting schema can then be sent to the form service so that a form can be generated (e.g., if necessary). If there is a persisted form for the custom resource type in the organization, then it can be retrieved from the database table form form_definition. If there is no persisted form, the resource type from the request payload can be used to generate a form. The generated (or persisted, if applicable) form is retrieved. It is passed on to the read-only form-renderer alongside the properties of the Custom Resource. The properties of the Custom Resource show on the right (e.g., after ˜1-2 seconds) (see the flow chart illustrated in FIG. 2, which describes the communication performed to retrieve a Custom Resource type customized form). The user now sees a read-only form renderer along with all properties of the Custom Resource type.

In the admin flow, an admin can open Cloud Assembly, open the “Design” tab, go to the “Custom Resources” tab, and open an existing custom resource type or begin creating a new one. (See FIG. 2). Regardless of whether the Custom Resource type is based on a vRO workflow or ABX actions, the Properties tab will now display a schema which is editable (opposed to a read-only schema, like in previous versions). The user can edit the schema. If the modifications are valid, then the Custom Resource type can be saved. If not, then the save button will be greyed out and disabled an alert with a text message describing the invalid property will appear.

An example of a Custom Resource type schema in a yaml format can be:

```
type: object
properties:
  name:
    type: string
    title: name
    default: Your Neighbourhood School
  notes:
    type: array
    items:
      type: object
      properties:
        key:
          type: string
          title: Key
        value:
          type: string
          title: Value
aliases:
  type: array
  items:
    type: string
  default:
    - alias 1
    - alias2
maxGrade:
  type: number
  title: maxGrade
  default: 12
newSchool:
  type: object
  properties:
    id:
      type: string
      title: id
    name:
      type: string
      title: name
    type:
      type: string
      title: type
    notes:
      type: string
      title: notes
    aliases:
      type: string
      title: aliases
    maxGrade:
      type: string
      title: maxGrade
computed: true
```

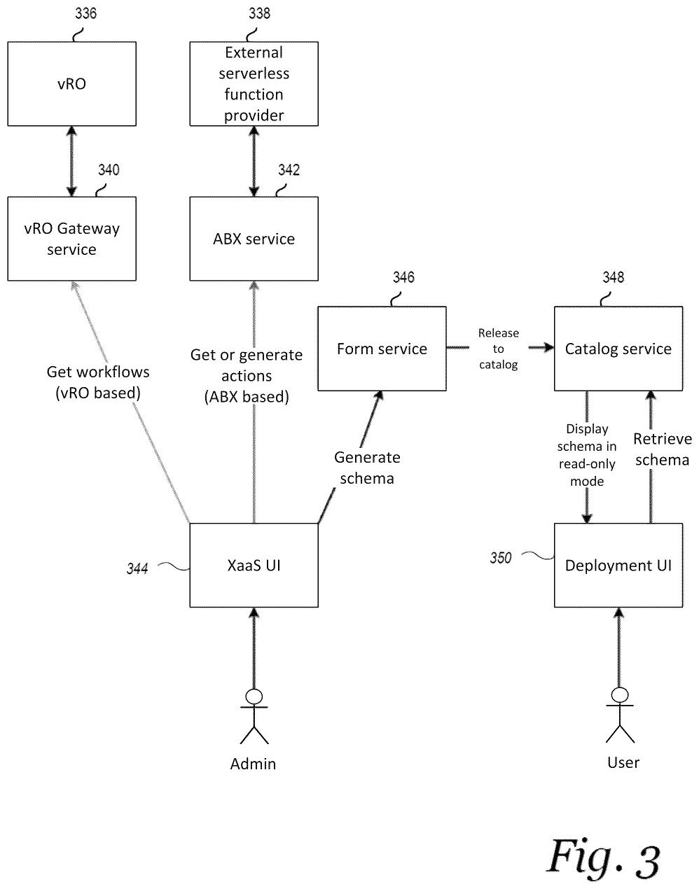

The workflow schema shown in the deployment of FIG. 3 includes the first use case, when a user uses vRO workflows, and the second use case, when a user uses ABX actions.

In some embodiments, a validation type can be that a property's maximum value must be larger than or equal to the minimum value. In some embodiments, a validation type can be that a property's minimum value must be smaller than or equal to the default value. In some embodiments, a validation type can be that a property's maximum value must larger than or equal to the default value. In some embodiments, a validation type can be that if a property is read only, it must have a default value. In some embodiments, a validation type can be that if a property has a pattern, the default value must match it. In some embodiments, a validation type can be that if a property has a format, the default value must match it. In some embodiments, a validation type can be that if a property has an enumerated value, the default value must match it. In some embodiments, a validation type can be that all validations are applicable for the nested properties. In some embodiments, a validation type can be, for vRO-based resource types, that it is not possible to change the property's type. In some embodiments, a validation type can be, for vRO-based resource types, that it is not possible to remove the output property. In some embodiments, a validation type can be that it is possible to hide or show input properties.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

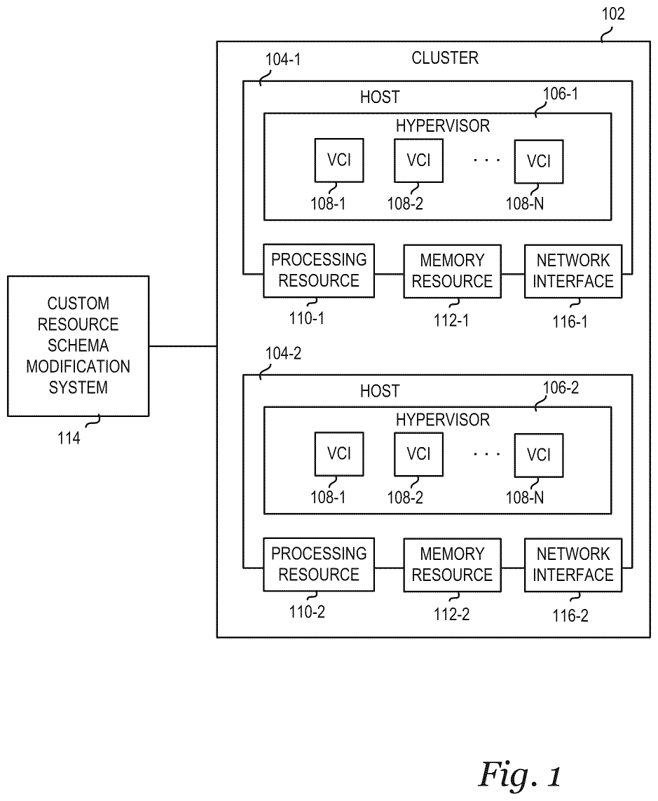

The figures herein follow a numbering convention in which the first digit or digits correspond to the drawing figure number and the remaining digits identify an element or component in the drawing. Analogous elements within a Figure may be referenced with a hyphen and extra numeral or letter. Such analogous elements may be generally referenced without the hyphen and extra numeral or letter. For example, elements 108-1, 108-2, and 108-N in FIG. 1 may be collectively referenced as 108. As used herein, the designator “N”, particularly with respect to reference numerals in the drawings, indicates that a number of the particular feature so designated can be included. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

FIG. 1 is a diagram of a host and a system for custom resource schema modification according to one or more embodiments of the present disclosure. The system can include a cluster 102 in communication with a custom resource schema modification system 114. The cluster 102 can include a first host 104-1 with processing resources 110-1 (e.g., a number of processors), memory resources 112-1, and/or a network interface 116-1. Similarly, the cluster 102 can include a second host 104-2 with processing resources 110-2, memory resources 112-2, and/or a network interface 116-2. Though two hosts are shown in FIG. 1 for purposes of illustration, embodiments of the present disclosure are not limited to a particular number of hosts. For purposes of clarity, the first host 104-1 and/or the second host 104-2 (and/or additional hosts not illustrated in FIG. 1) may be generally referred to as “host 104.” Similarly, reference is made to “hypervisor 106,” “VCI 108,” “processing resources 110,” memory resources 112,” and “network interface 116,” and such usage is not to be taken in a limiting sense.

The host 104 can be included in a software-defined data center. A software-defined data center can extend virtualization concepts such as abstraction, pooling, and automation to data center resources and services to provide information technology as a service (ITaaS). In a software-defined data center, infrastructure, such as networking, processing, and security, can be virtualized and delivered as a service. A software-defined data center can include software-defined networking and/or software-defined storage. In some embodiments, components of a software-defined data center can be provisioned, operated, and/or managed through an application programming interface (API).

The host 104-1 can incorporate a hypervisor 106-1 that can execute a number of VCIs 108-1, 108-2, . . . , 108-N (referred to generally herein as “VCIs 108”). Likewise, the host 104-2 can incorporate a hypervisor 106-2 that can execute a number of VCIs 108. The hypervisor 106-1 and the hypervisor 106-2 are referred to generally herein as a hypervisor 106. The VCIs 108 can be provisioned with processing resources 110 and/or memory resources 112 and can communicate via the network interface 116. The processing resources 110 and the memory resources 112 provisioned to the VCIs 108 can be local and/or remote to the host 104. For example, in a software-defined data center, the VCIs 108 can be provisioned with resources that are generally available to the software-defined data center and not tied to any particular hardware device. By way of example, the memory resources 112 can include volatile and/or non-volatile memory available to the VCIs 108. The VCIs 108 can be moved to different hosts (not specifically illustrated), such that a different hypervisor manages (e.g., executes) the VCIs 108. The host 104 can be in communication with the custom resource schema modification system 114. In some embodiments, the custom resource schema modification system 114 can be deployed on a server, such as a web server.

The custom resource schema modification system 114 can include computing resources (e.g., processing resources and/or memory resources in the form of hardware, circuitry, and/or logic, etc.) to perform various operations to modify a custom resource schema, as described in more detail herein.

FIG. 2 is a flow chart illustrating communication performed to retrieve a custom resource type customized form according to one or more embodiments of the present disclosure. As shown, FIG. 2 includes a form service 220, a deployment UI 222, and a catalog service 224. The user can open a deployment that contains a custom resource type and select a custom resource causing a request for a schema to be sent to the catalog service 226. At 228, the deployment UI 222 receives the schema of the selected custom resource from the catalog service 224 (table prov_resource_type in catalog-db). At 230, the resulting schema is sent to the form service 220 so that a form could be generated, if necessary. If there is a persisted form for the custom resource type in the organization, then it can be retrieved from the database table form_formdefinition. If there is no persisted form, the resource type from the request payload can be used to generate a form. The generated (or persisted, if applicable) form is retrieved at 232. It is passed on to the read-only form-renderer alongside the properties of the custom resource. The properties of the custom resource show on the right after a period of time (e.g., ˜1-2 seconds). The user can then see a read-only form renderer with all of the properties of the custom resource type at 234.

FIG. 3 illustrates a workflow schema according to one or more embodiments of the present disclosure. As shown in FIG. 3, a user (e.g., an administrator) of a UI (e.g., XaaS) 344 can obtain automation platform workflows from a gateway service 340 in communication with an automation platform (e.g., vRO) 336. The user of the UI 344 can obtain and/or generate actions (e.g., ABX-based actions) from an ABX service 342 in communication with an external serverless function provider 338. Serverless is a development model that allows developers to build and run small, lightweight scripts of code without having to manage servers. Under a serverless model, a cloud provider runs physical servers and dynamically allocates their resources on behalf of users who can deploy code straight into a public or private cloud. This makes for a good extensibility mechanism for cloud users who wish to concentrate on their apps instead of managing complex infrastructure. The user of the UI 344 can generate a schema, using a form service 346, which can be released to a catalog service 348. A user (e.g., a customer) can use a deployment UI 350 to retrieve the schema from the catalog service 348 and display the schema in read-only mode, as previously described.

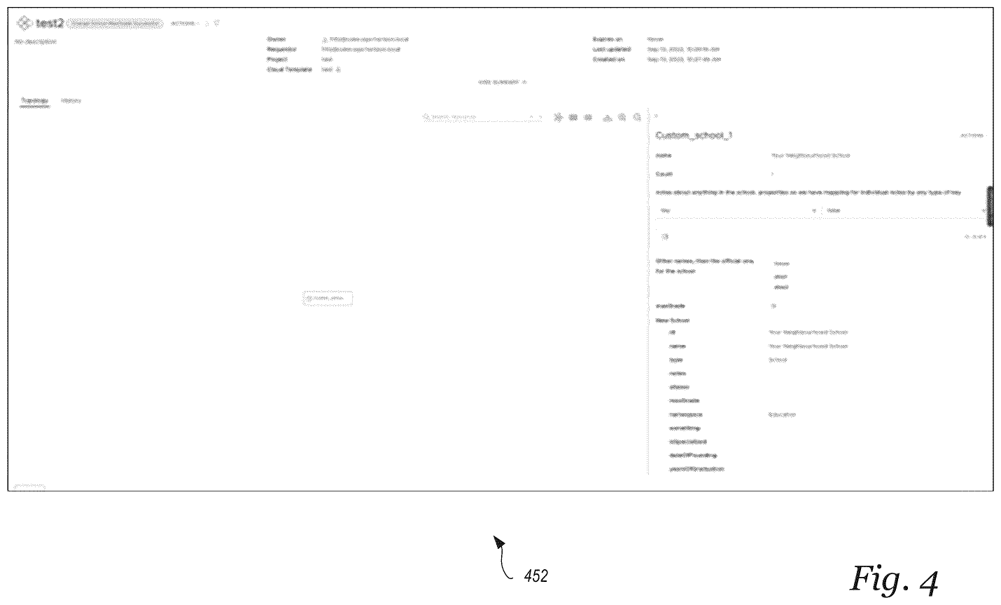

FIG. 4 is a screen shot of an example interface including a deployment according to one or more embodiments of the present disclosure. As shown in the example illustrated in FIG. 4, properties of a custom resource “Custom_school_1” can be displayed in a portion (e.g., a right-hand portion) of the user interface. These custom properties can include name, count, other names, maxGrade, etc. It is noted that these properties are provided for example purposes and are not to be taken in a limiting sense. The properties 452, as described herein, are retrieved according to the steps described above in connection with FIG. 2.

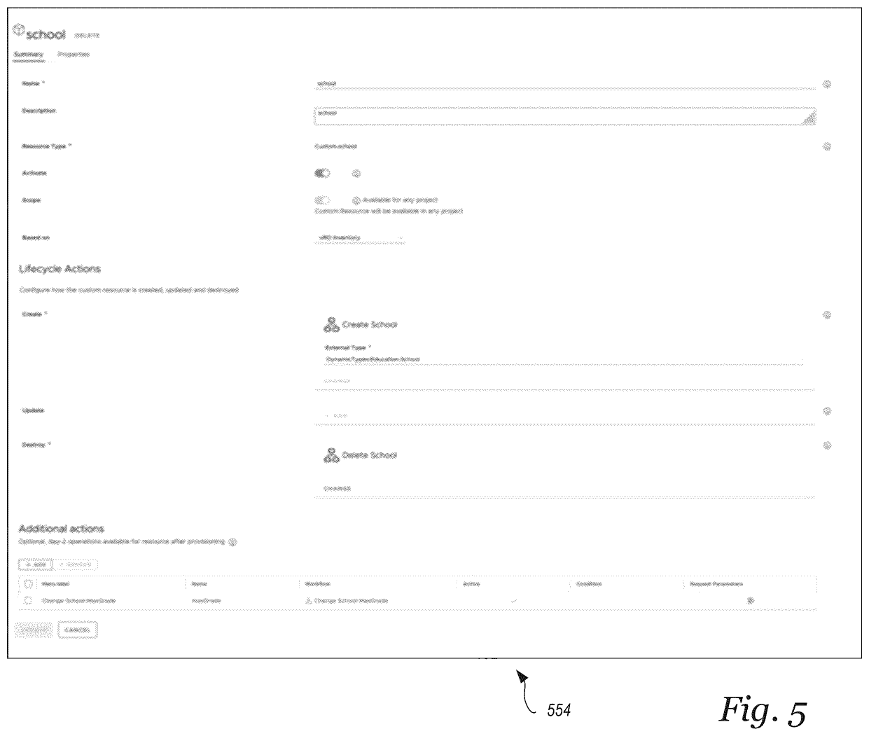

FIG. 5 is a screen shot of an example interface 554 associated with customizing the display of custom resources according to one or more embodiments of the present disclosure. The UI 554 illustrated in FIG. 5 shows a “summary” of a custom resource type “school.” The summary can include information such as name, description, resource type, scope, etc.

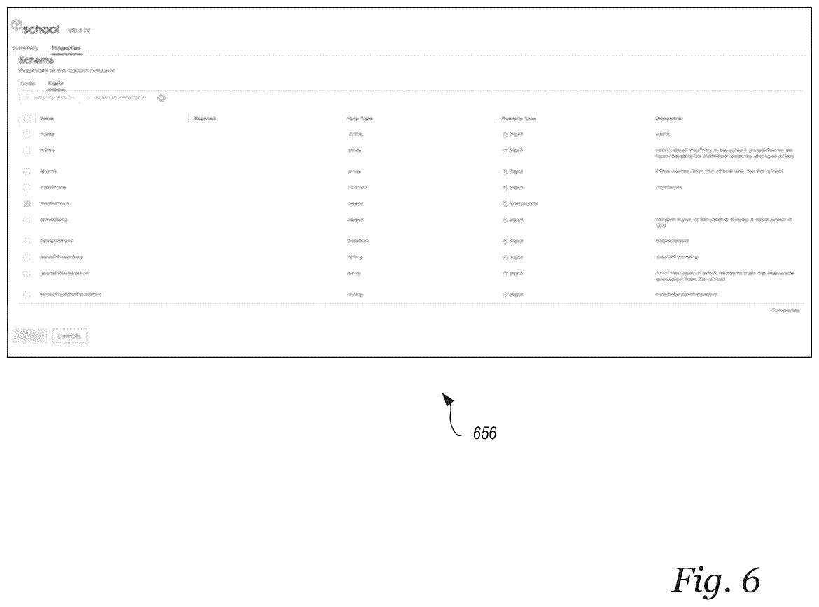

FIG. 6 is a screen shot of an example interface 656 associated with editing a schema as a table according to one or more embodiments of the present disclosure. Selection of the “properties” tab shown in FIG. 5 can cause the display of the interface 656 illustrated in FIG. 6, for instance. The interface 656 can be a table that may be particularly useful for customers that are not familiar with properties and/or schemas. The interface can allow the modification of a property's name, the type of data associated with the property, the type of the property, and/or a description of the property, for instance.

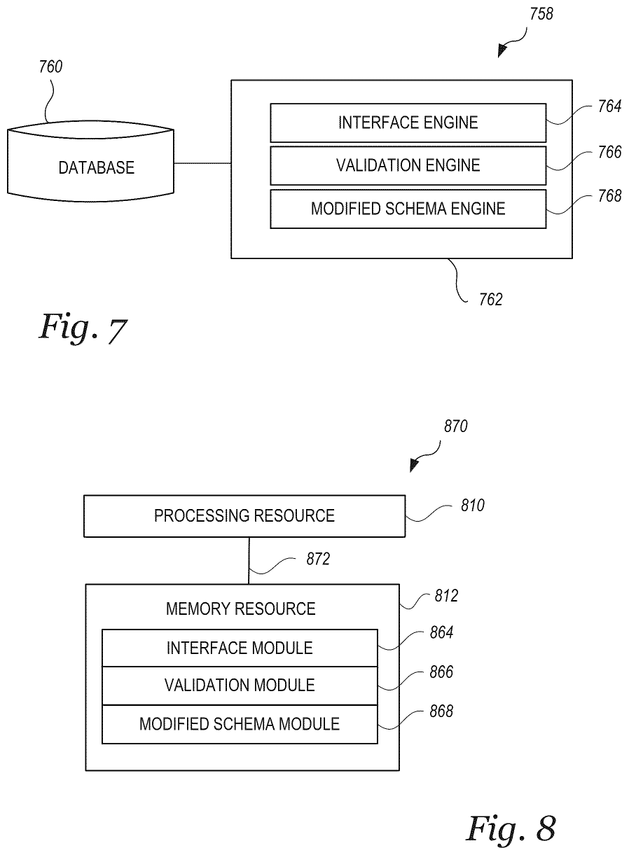

FIG. 7 illustrates a system 758 for custom resource schema modification according to one or more embodiments of the present disclosure. The system 758 can include a database 760, a subsystem 762, and/or a number of engines, for example an interface engine 764, a validation engine 766, and/or a modified schema engine 768, and can be in communication with the database 760 via a communication link. The system 758 can include additional or fewer engines than illustrated to perform the various functions described herein. The system 758 can represent program instructions and/or hardware of a machine (e.g., machine 870 as referenced in FIG. 8, etc.). As used herein, an “engine” can include program instructions and/or hardware, but at least includes hardware. Hardware is a physical component of a machine that enables it to perform a function. Examples of hardware can include a processing resource, a memory resource, a logic gate, etc.

The number of engines can include a combination of hardware and program instructions that is configured to perform a number of functions described herein. The program instructions (e.g., software, firmware, etc.) can be stored in a memory resource (e.g., machine-readable medium) as well as hard-wired program (e.g., logic). Hard-wired program instructions (e.g., logic) can be considered as both program instructions and hardware.

In some embodiments, the interface engine 764 can include a combination of hardware and program instructions that is configured to provide an interface for modifying a schema of a custom resource in a virtualized environment. The interface can include a first portion configured to receive modifications to summary information corresponding to the custom resource. The interface can include a second portion configured to receive modifications to properties corresponding to the schema of the custom resource. In some embodiments, the validation engine 766 can include a combination of hardware and program instructions that is configured to validate the modified schema. In some embodiments, the modified schema engine 768 can include a combination of hardware and program instructions that is configured to save the modified schema of the custom resource responsive to the validation being successful.

FIG. 8 is a diagram of a machine 870 for custom resource schema modification according to one or more embodiments of the present disclosure. The machine 870 can utilize software, hardware, firmware, and/or logic to perform a number of functions. The machine 870 can be a combination of hardware and program instructions configured to perform a number of functions (e.g., actions). The hardware, for example, can include a number of processing resources 810 and a number of memory resources 812, such as a machine-readable medium (MRM) or other memory resources 812. The memory resources 812 can be internal and/or external to the machine 870 (e.g., the machine 870 can include internal memory resources and have access to external memory resources). In some embodiments, the machine 870 can be a virtual computing instance (VCI) or other computing device. The term “VCI” covers a range of computing functionality. The term “virtual machine” (VM) refers generally to an isolated user space instance, which can be executed within a virtualized environment. Other technologies aside from hardware virtualization can provide isolated user space instances, also referred to as data compute nodes. Data compute nodes may include non-virtualized physical hosts, VMs, containers that run on top of a host operating system without a hypervisor or separate operating system, and/or hypervisor kernel network interface modules, among others. Hypervisor kernel network interface modules are non-VM data compute nodes that include a network stack with a hypervisor kernel network interface and receive/transmit threads. The term “VCI” covers these examples and combinations of different types of data compute nodes, among others.

The program instructions (e.g., machine-readable instructions (MRI)) can include instructions stored on the MRM to implement a particular function (e.g., an action such as processing streams of change events). The set of MRI can be executable by one or more of the processing resources 810. The memory resources 892 can be coupled to the machine 870 in a wired and/or wireless manner. For example, the memory resources 812 can be an internal memory, a portable memory, a portable disk, and/or a memory associated with another resource, e.g., enabling MRI to be transferred and/or executed across a network such as the Internet. As used herein, a “module” can include program instructions and/or hardware, but at least includes program instructions.

Memory resources 812 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory, optical memory, and/or a solid state drive (SSD), etc., as well as other types of machine-readable media.

The processing resources 810 can be coupled to the memory resources 812 via a communication path 872. The communication path 872 can be local or remote to the machine 870. Examples of a local communication path 872 can include an electronic bus internal to a machine, where the memory resources 812 are in communication with the processing resources 810 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 872 can be such that the memory resources 812 are remote from the processing resources 810, such as in a network connection between the memory resources 812 and the processing resources 810. That is, the communication path 872 can be a network connection. Examples of such a network connection can include a local area network (LAN), wide area network (WAN), personal area network (PAN), and the Internet, among others.

As shown in FIG. 8, the MRI stored in the memory resources 812 can be segmented into a number of modules 864, 866, 868 that when executed by the processing resources 810 can perform a number of functions. As used herein a module includes a set of instructions included to perform a particular task or action. The number of modules 864, 866, 868 can be sub-modules of other modules. For example, the modified schema module 868 can be a sub-module of the validation module 866 and/or can be contained within a single module. Furthermore, the number of modules 864, 866, 868 can comprise individual modules separate and distinct from one another. Examples are not limited to the specific modules 864, 866, 868 illustrated in FIG. 8.

One or more of the number of modules 864, 866, 868 can include program instructions and/or a combination of hardware and program instructions that, when executed by a processing resource 810, can function as a corresponding engine as described with respect to FIG. 7. For example, the interface module 864 can include program instructions and/or a combination of hardware and program instructions that, when executed by a processing resource 810, can function as the interface engine 764.

For example, the machine 870 can include an interface module 864, which can include instructions to provide an interface for modifying a schema of a custom resource in a virtualized environment. The interface can include a first portion configured to receive modifications to summary information corresponding to the custom resource and a second portion configured to receive modifications to properties corresponding to the schema of the custom resource. For example, the machine 870 can include a validation module 866, which can include instructions to validate the modified schema. For example, the machine 870 can include a modified schema module 868, which can include instructions to save the modified schema of the custom resource responsive to the validation being successful.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method, comprising:
providing an interface for modifying a schema of a custom resource in a virtualized environment, wherein the interface includes:
a first portion configured to receive modifications to summary information corresponding to the custom resource; and
a second portion configured to receive modifications to properties corresponding to the schema of the custom resource;
validating the modified schema; and
saving the modified schema of the custom resource responsive to the validation being successful.

2. The method of claim 1, wherein the summary information includes:
a name of the custom resource;
a description of the custom resource; and
a type of the custom resource.

3. The method of claim 1, wherein the second portion is configured to receive code as the modifications to properties corresponding to the schema of the custom resource.

4. The method of claim 3, wherein the code is in a YAML format.

5. The method of claim 1, wherein the second portion includes a table configured to receive properties of the custom resource.

6. The method of claim 1, wherein validating the modified schema includes:
determining whether a maximum value of a property is equal to or larger than a minimum value of the property;
determining whether a minimum value of the property is equal to or smaller than a default value of the property;
determining whether a maximum value of the property is equal to or larger than a default value of the property; and
determining whether a default value of a property matches a pattern and a format of the property.

7. The method of claim 1, wherein the method includes preventing the modified schema from being saved and providing a notification responsive to the validation being unsuccessful.

8. A non-transitory machine-readable medium having instructions stored thereon which, when executed by a processor, cause the processor to:
provide an interface for modifying a schema of a custom resource in a virtualized environment, wherein the interface includes:
a first portion configured to receive modifications to summary information corresponding to the custom resource; and
a second portion configured to receive modifications to properties corresponding to the schema of the custom resource;
validate the modified schema; and
save the modified schema of the custom resource responsive to the validation being successful.

9. The medium of claim 8, wherein the summary information includes:
a name of the custom resource;
a description of the custom resource; and
a type of the custom resource.

10. The medium of claim 8, wherein the second portion is configured to receive code as the modifications to properties corresponding to the schema of the custom resource.

11. The medium of claim 10, wherein the code is in a YAML format.

12. The medium of claim 8, wherein the second portion includes a table configured to receive properties of the custom resource.

13. The medium of claim 8, wherein in the instructions to validate the modified schema include instructions to:
determine whether a maximum value of a property is equal to or larger than a minimum value of the property;
determine whether a minimum value of the property is equal to or smaller than a default value of the property;
determine whether a maximum value of the property is equal to or larger than a default value of the property; and
determine whether a default value of a property matches a pattern and a format of the property.

14. The medium of claim 8, including instructions to prevent the modified schema from being saved and provide a notification responsive to the validation being unsuccessful.

15. A system, comprising:
an interface engine configured to provide an interface for modifying a schema of a custom resource in a virtualized environment, wherein the interface includes:
a first portion configured to receive modifications to summary information corresponding to the custom resource; and
a second portion configured to receive modifications to properties corresponding to the schema of the custom resource;
a validation engine configured to validate the modified schema; and
a modified schema engine configured to save the modified schema of the custom resource responsive to the validation being successful.

16. The system of claim 15, wherein the summary information includes:
a name of the custom resource;
a description of the custom resource; and
a type of the custom resource.

17. The system of claim 15, wherein the second portion is configured to receive code as the modifications to properties corresponding to the schema of the custom resource.

18. The system of claim 17, wherein the code is in a YAML format.

19. The system of claim 15, wherein the second portion includes a table configured to receive properties of the custom resource.

20. The system of claim 15, wherein the validation engine is configured to:
determine whether a maximum value of a property is equal to or larger than a minimum value of the property;
determine whether a minimum value of the property is equal to or smaller than a default value of the property;
determine whether a maximum value of the property is equal to or larger than a default value of the property; and
determine whether a default value of a property matches a pattern and a format of the property.
